(19) United States
(12) Patent Application Publication
(10) Pub. No.: US 2002/0118194 A1
(43) Pub. Date: Aug. 29, 2002

(54) Triggered non-linear animation

(76) Inventors: Robert Lanciault, St-Julie (CA); Michel Besner, Notre-Dame de I'lle Perrot (CA)

Correspondence Address: NIXON & VANDERHYE P.C., 8th Floor, 1100 North Glebe Road, Arlington, VA, 22201, US

(21) Appl. No.: 09/793,407

(22) Filed: Feb. 27, 2001

(51) Int. Cl. G06T 15/70

(52) U.S. Cl. 345/473

(57) ABSTRACT

A method and apparatus are provided for generating animation data, comprising the steps of displaying a character (502) that can be animated; triggering (605) the reading of input animation sequences (305) in response to manual operation of manually controllable input means (108, 109, 110); animating (606) said character (502) in response to said input animation sequences (305); and storing (608) said triggered animation sequence (907) in storage means as an output animation sequence (401).

### BACKGROUND OF THE INVENTION

1. Field of the Invention

The present invention relates to the real-time triggering of motion for animating a character, wherein said character is animated with a motion clip in response to input from input devices, and the recording thereof. The invention relates to apparatus in a computer animation system, a method for animating a character and a computer carrying medium.

2. Description of the Related Art

In the field of computer-aided character animation, character motion is generally achieved by means of altering the three-dimensional position of the components of said character, i.e. body parts of said character, over a succession of frames, known as a motion clip, and with reference to a pre-production script which lists the characters' required motions in relation to a narrative.

Numerous methods are known in order to generate motion or action data with which a character is animated. In the field of computer-aided character animation, most of those known methods involve motion capture: an actor's body parts are equipped with optical or radio transmitting sensors and, upon said actor performing motions corresponding to actions, the three-dimensional position of said body parts of said actor are captured by means of said sensors. Said captured motion data is then applied to a character, such that the characters body parts replicate the motions of the captured body parts of the actor. In this way, a real performance may be abstracted into the animation space whereafter this extracted data may be used to create a real animation from any appropriate character description and character registration data.

One of the more important problems of the above prior art is the cost associated with the purchase or even temporary hire of motion-capture equipment and the cost of operating of such systems, which can artificially inflate the animation budget of any production to such an extent as to seriously limit the creative input of animators and/or the extent of the animation contents of said production. This economical problem is being partly addressed by the increasing availability of libraries of captured performance data for purchase or hire, but this latest development does not fully remedy the problems associated with using motion capture equipment. From a creative point of view, an animator is still constrained by which movements are available for use in said libraries and, from an operational point of view, an animator must still apply motion clips to a character sequentially one-by-one, thus not in real-time, again to the detriment of creative animation and also uneconomically in terms of working time.

A significant enhancement of production quality and an opportunity to further reduce overall production costs are obtained according to the present invention by means of providing an apparatus and method to generate character motion from libraries of motion clips that may potentially, but not necessarily, originate from a motion capture system. Said character motion comprises one or a sequence of motion clips triggered in real-time by means of input devices.

### BRIEF SUMMARY OF THE INVENTION

According to a first aspect of the present invention, there is provided an apparatus for triggering animation data comprising manually controllable input means, visual display means,processing means, memory means and storage means for storing input animation sequences and output animation sequences. Said memory means includes instructions to configure said processing means to display a character that can be animated. Said memory means also includes instructions to trigger the reading of said input animation sequences in response to manual operation of said manually controllable input means. Said memory means also includes instructions to animate said character in response to said input animation sequences; and said memory means finally includes instructions to store said triggered animation sequence in said storage means as an output animation sequence.

According to a second aspect of the present invention, there is provided a method of generating animation data, comprising the steps of displaying a character that can be animated; triggering the reading of input animation sequences in response to manual operation of manually controllable input means; animating said character in response to said input animation sequences; and storing said triggered animation sequence in storage means as an output animation sequence.

The invention allows animators to animate any specific character with a structure sensibly similar to the structure of a generic character in real-time from a library of generic body part motion clip triggered by one or a plurality of input devices.

### BRIEF DESCRIPTION OF THE SEVERAL VIEWS OF THE DRAWINGS

FIG. 1 shows a computer animation system for animating a character according to the present invention;

FIG. 2 illustrates the physical structure of the computer system identified in FIG. 2;

FIG. 3 illustrates the memory map of instructions stored within said computer system;

FIG. 4 illustrates a library of generic motion clips with which to animate a generic character;

FIG. 5 illustrates the association of a generic humanoid topology with nodes;

FIG. 6 shows operations performed by the computer animation system shown in FIG. 1 according to the invention;

FIG. 7 summarises operations performed according to the animation application shown in FIG. 3 in order to animate a character according to the invention;

FIG. 8 summarises operations performed according to the animation application to manage the transition between a current motion clip and a triggered motion clip;

FIG. 9 illustrates a graphical edit tree comprising several motion clips;

FIG. 10 summarises operations performed according to the animation application in order to save the animation sequence subsequently to the operations shown in FIGS. 7 and 8;

### BEST MODE FOR CARRYING OUT THE INVENTION

The invention will now be described by way of example only with reference to the previously identified drawings.

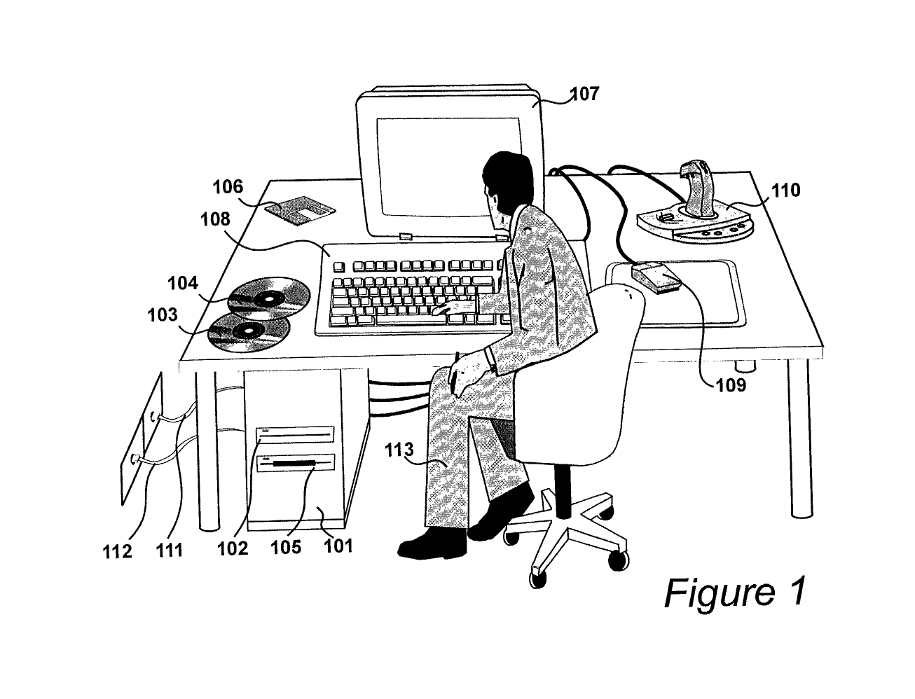

A computer animation system is shown in FIG. 1 and includes a programmable computer 101 having a drive 102 for receiving CD-ROMs 103 and writing to CD-RAMs 104 and a drive 105 for receiving high-capacity magnetic disks, such as zip disks 106. According to the invention, computer 101 may receive program instructions via an appropriate CD-ROM 103 or action data may be written to a rewritable CD-RAM 104, and motion clips may be received from or action data may be written to a zip disk 106 by means of drive 105.

Output data is displayed on a visual display unit 107 and manual input is received via a keyboard 108, a mouse 109 and a joystick 110. Data may also be transmitted and received over a local area network 111 or the Internet by means of modem connection 112 by the computer animation system operator, i.e. animator 113. In addition to writing animation data in the form of action data to a disk 106 or CD-RAM 104, completed rendered animation frames may be written to said CD-RAM 104 such that animation sequence data, in the form of video material, may be transferred to a compositive station or similar.

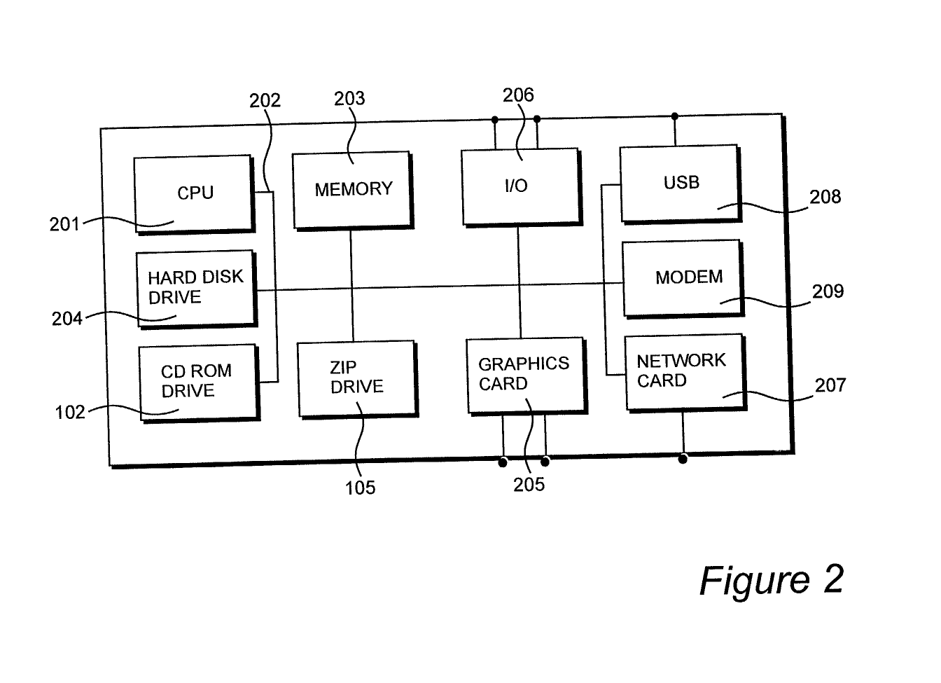

The components of computer system 101 are detailed in FIG. 2. The system includes a Pentium III™ central processing unit (CPU) 201 operating under instructions received from random access memory 203 via a system bus 202. Memory 203 comprises one hundred and twenty-eight megabytes of randomly accessible memory and executable programs which, along with data, are received via said bus 202 from a hard disk drive 204. A graphics card 205 and input/output interface 206, a network card 207, a zip drive 105, a CD-ROM drive 102, a Universal Serial Bus (USB) interface 208 and a modem 209 are also connected to bus 202. Graphics card 205 supplies graphical data to visual display unit 107 and the I/O device 206 or USB 208 receives input commands from keyboard 108, mouse 109 and joystick 110. Zip drive 105 is primarily provided for the transfer of data, such as performance data, and CD-ROM drive 102 is provided for the loading of new executable instructions to the hard disk drive 204 and the saving of animation sequence data in video- or data form.

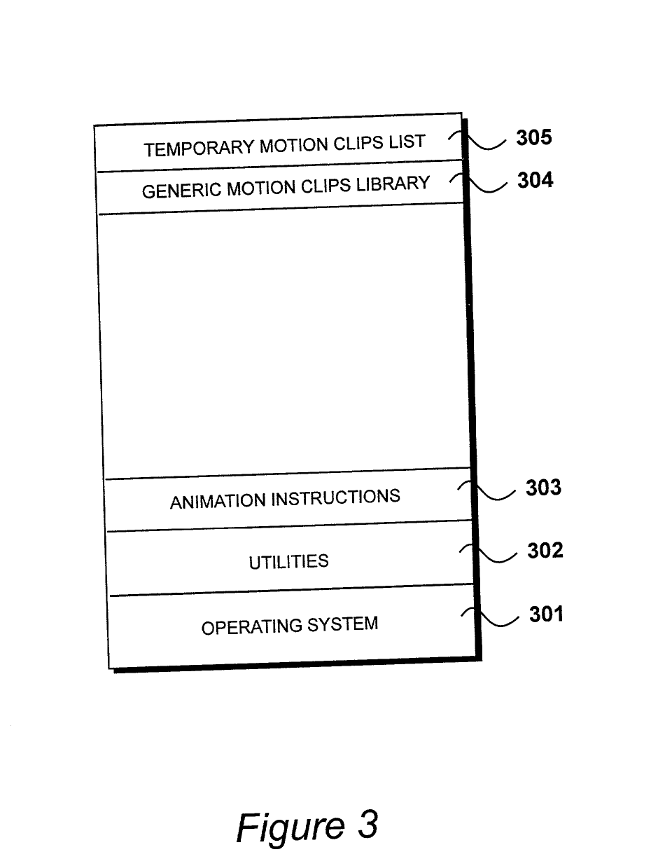

A summary of the contents of the main memory 203 of the computer system 101 is shown in FIG. 3, as subsequently to the loading of instructions according to the invention.

Main memory 203 includes primarily an operating system 301, which is preferably Microsoft®, Windows® NT4, as said operating system is considered by those skilled in the art to be particularly stable when using computationally intensive applications, such as an animation application. Main memory 203 also includes utilities 302 and, in a preferred embodiment of the present invention, such utilities include OpenGL rendering instructions, an Internet Browser and configuration instructions for joystick 110.

In addition to animation instructions 303, which represent the executable portion of the animation application according to the present invention, main memory 303 includes data sets from which and with which animation instructions 303 animate a character. Said data sets include primarily a generic motion clips library 304. Eventually, said data sets also include a temporary motions list 305.

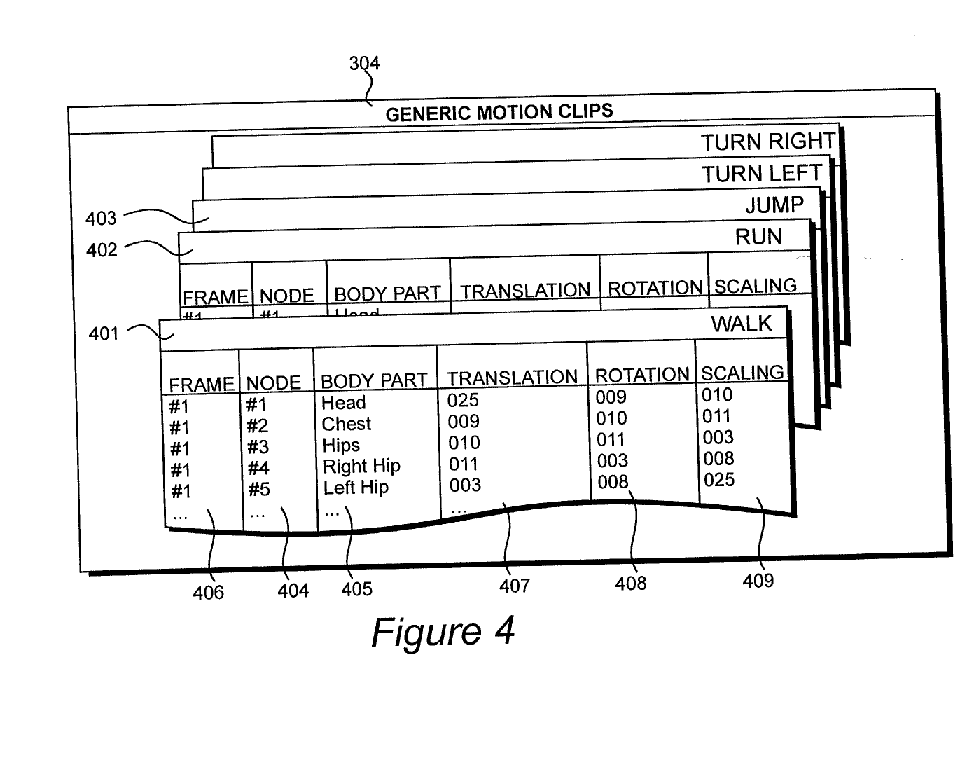

The generic motion clips library 304 is illustrated in FIG. 4. Said generic motions library 304 stores motion clips from previously captured performance data indexed under the descriptive name of the motion, ie “walk” 401, “run” 402, “jump” 403 etc., or motion clips as sets of keyframes not previously captured from performance data but also indexed under the descriptive name of the motion for clarity of reference.

For each indexation 401, 402 and 403 of said previously captured performance or sets of keyframes, its respective data comprises a comprehensive array of representative nodes 404 uniquely defining the various body parts 405 of a generic character. Said respective data also comprises the three-dimensional co-ordinates of said nodes 404, expressed in terms of translation 407, rotation 408 and scaling 409 in each frame within a succession of frames 406 at least equivalent to one cycle of the motion.

For instance, in the case of the “walk” motion clip 401, the data includes the translation 407, rotation 408 and scaling 409 co-ordinates of each of the nodes 404 defining the various body parts 405 of a generic character in each frame, over a succession of frames 406 of say twenty-five frames, starting with the generic character's left foot moving forward from a ‘rest’ position to said left foot returning to a ‘rest’ position after the right foot respectively left and returned to a resting position, thus defining a complete ‘walk’ motion 401.

Thus, upon triggering a generic motion clip within library 304 by means of animation instructions 303, a group of nodes 404 defining a generic character is animated with the triggered motion clip, as for each generic motion clip 401, 402, 403 etc. included in the generic motion clips library 304, the respective movements of each of the body parts 405 of a character can be correlated by way of the co-ordinates 407, 408, 409 of their respective nodes 404 over the succession of frames 406 defining the motion.

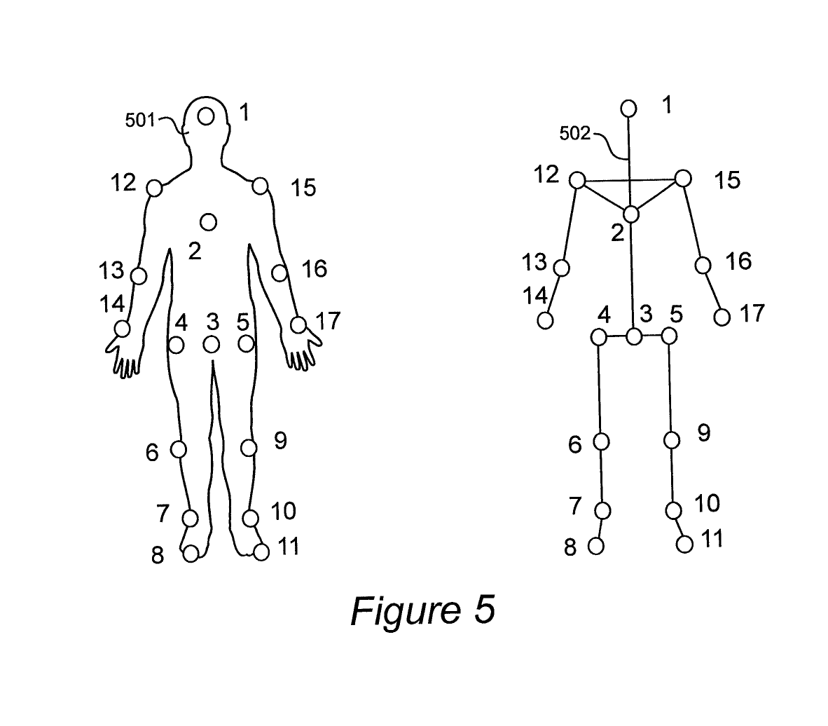

A group of nodes, such as group of nodes 404, defines this topology and is illustrated in FIG. 5.

As generic motion clips relate in most instances to captured performance data, most sets of nodes relate to a humanoid topology such as represented by generic actor 501, which is itself initially based on an actor performing said motions in the real world. Thus, whereas it would be perfectly acceptable for a character with a humanoid topology to be animated with a “jump” motion clip 403, and to render said jumping character in a compositing environment as performing said jump over an imaginary distance of say one mile, it would however not be acceptable to animate the body parts defining said imaginary humanoid character with motion performance captured from the body parts of an animal which uses four legs for motion over ground, as morphological differences invalidate the nodal configuration 501.

As the purpose of said nodes is to reference the movement in two- or three dimensions of body parts during a generic motion, said nodes are located at the joints between said body parts, or extremities, such that an ‘exo-skeleton’ 502 can be mathematically derived from said nodes in order to visualise the motion thereof with the least possible computational overhead allocated to character rendering, if any at all. Therefore, according to the invention, a character to be animated with triggered motion clips does not need to be fully or even partially rendered as a three-dimensional mathematical model comprising individual mathematically-modelled body parts constructed from polygons defining lines and curves and potentially over-laid with bitmapped polygonal textures, as motion clips can be triggered to only animate the exo-skeleton 502 in order to reduce the load of CPU 201.

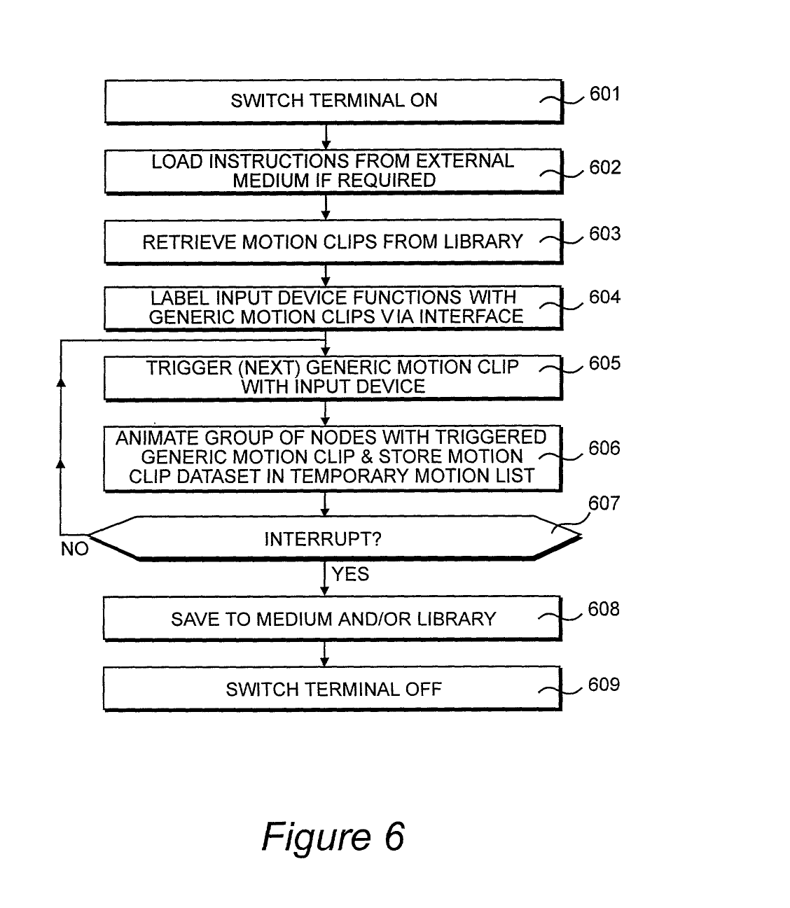

Operations performed by the computer animation system illustrated 101 in FIG. 1 in order to achieve triggered non-linear animation are identified in FIG. 6.

After switching computer 101 at step 601, program instructions are loaded at step 602 either from hard disk drive 204 or an external medium such as CD ROM 103 or local area network 111 or the Internet by means of modem connection 112. In order to initiate an animation session at said computer 101, upon completing step 602, motion clips, such as clips 401, 402 or 404 must first be retrieved from generic motion clips library 304 at step 603.

The present invention aims to provide animators with means with which to trigger motion clips in real-time. Thus, at step 604, the computer animation system operator 113 designates which I/O device, such as keyboard 108, mouse 109 or joystick 110 will be preferably used in order to trigger the generic motion clips during the animation session. In a preferred embodiment of the present invention, the device of choice with which to trigger motion clips at the next step 605 is the joystick 110. Preferably, joystick 110 is a Microsoft® SideWinder®, manufactured by the Microsoft Corporation in Redmond, Calif.

Thus, upon triggering a generic motion clip by means of joystick 110 at step 605, animation instructions 303 animate the group of nodes 404 defining the exo-skeleton 502 according to the triggered motion clip at step 606, and said animation is simultaneously displayed on visual display unit 107. As the animation program instructions animate the nodes with triggered motion clips, said animation instructions 303 also temporarily store data pertaining to every successively triggered motion clip in the temporary motion clips list 305 stored within the main memory. A question is then asked at step 607, which determines whether an ‘interrupt’ has been received from the operator 113 in order to cease triggering motion clips at step 607 and thus terminate the animation session, or alternatively, to return control to step 605, wherein the operator may continue to trigger additional motion clips to achieve an optimal animation sequence.

At step 608 the generated animation sequence is then saved to either hard disk 204, CD-RAM 104 or zip disk 106, or any combination thereof. Data relating to said animation sequence may also be saved to the library of generic motion clips 304 in order enrich said library with composited motion clips composed of generic motion clips. The animation computer 101 is then switched off at step 609.

In order for an animator operating animation computer system 101 to animate a character in real-time, the various generic motion clips 401, 402 and 403 contained within generic motion clips library 304 are mapped as labels to one or a plurality of input devices at step 604.

Animation instructions 303 allow the animator to assign, or ‘map’, generic motion clips to the various functions of input devices such that, when said input devices are interacted with by the animator, i.e. triggered, the input string received from said input devices triggers animation instructions 303 and preferably, but not necessarily, utilities 302 to display said motion clip as a succession of frames.

Various interfaces are known from the prior art to enable an animator to assign specific instruction strings, or labels, to specific input devices and should be easy for those skilled in the art to implement. If an animator chooses to use keyboard 108 as the input device with which to trigger motion clips, then an interface is presented to said animator which features a motion clips list, which lists all of the available generic motion clips contained within generic motions library 304. The animator subsequently hits an appropriate keystroke which then designates the keyboard key the animator should hit in order for the animation instructions 303 to animate the group of nodes 404 according to the motion clip associated with said key. In the example, if the animator hits the ‘W’ key in regard of the ‘walk’ motion clip 401, then if the animator hits a ‘W’ key, the animation application will animate the group of nodes 404 with a “walk” motion clip. Similarly, if the animator 113 hits the ‘J’ key in regard of the ‘jump’ motion clip 403, then if the animator hits a ‘J’ key, the animation application will animate the group of nodes 404 with a “jump” motion and so on and so forth.

In a preferred embodiment of the present invention, however, the input device of choice in order to trigger motion clips with which to animate the nodes is joystick 110, preferably of the type known as Microsoft® Sidewinder®, manufactured by the Microsoft Corporation in Redmond, Calif.

According to a preferred embodiment of the present invention, more than one game controller could be connected to animation computer 101 in the course of an animation session, in order to trigger motion clips to simultaneously animate several characters independently.

Any of such game controllers are preferably connected to the animation computer 101 by means of Universal Serial Bus (USB) 210. USB 210 increases the dynamic nature of the animation system 101 in that it makes it easier for the animator to switch between multiple controllers on the animation system if said animator must simultaneously animate several characters alone as, with making use of the USB connection rather than a serial connection, a fairly extensive number of controllers can be daisy-chained, potentially allowing more than fifty game controllers to simultaneously trigger animation in real-time.

When joystick 110 is selected at step 604 as the preferred input device, an interface, which again is easy for those skilled in the art to implement especially if configuration instructions for joystick 110 are loaded into main memory 203, is presented to said animator which features a motion clips list, which lists all of the available generic motions contained within generic motions library 304. The animator 113 subsequently activates an appropriate function of joystick 110, which then designates the joystick function the animator should trigger in order for the animation instructions 303 to animate the nodes 404 according to the motion clip associated with said function. If the animator chooses to use a plurality of dedicated game controllers simultaneously or successively, the animation instructions 303 prompts the animator for the number of different devices and description and enumeration thereof within the interface.

The main benefits of choosing joystick 110 as the preferred input device in the preferred embodiment over keyboard 108 or even mouse 109 is that said joystick, especially if according to the type described there above, offers the animator unparalleled intuitiveness for the real-time control over the triggering of motion clips with which to animate the group of nodes 404.

Upon completing the association of generic motion clips contained within generic motions library 304 with joystick 110, the animator is now ready to trigger generic motions of the group of nodes 404 in real-time by means of an input device at step 605. The animation instructions 303 poll the attached game controller(s) in a thread and the main thread of the animation instructions waits on this poll.

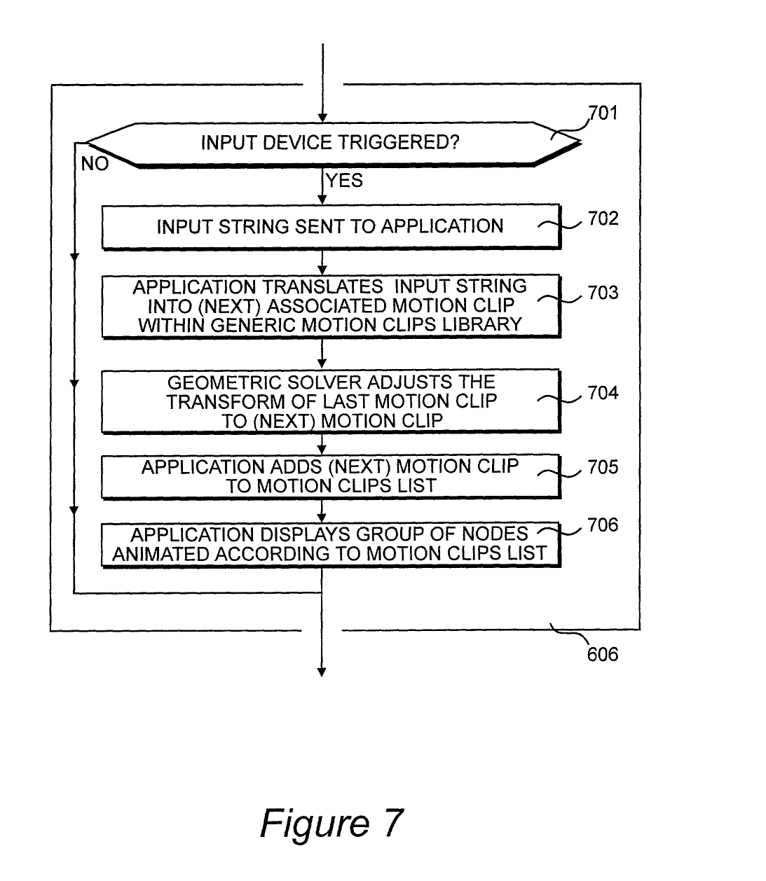

Should an input string be received from joystick 110 upon interaction between an animator and said joystick 110, animation instructions 303 subsequently animate the group of nodes 404 with the appropriate triggered generic motion clip and temporarily record data pertaining to the triggered generic motion clip according to step 606, the operations of which are summarised in FIG. 7.

At step 701, the question is asked as to whether an input device has been triggered. In other words, animation instructions 303 poll the attached input device in a thread, with said thread reporting changes in the original configuration of the input device if said input device is interacted with by the animator at step 605 and thus answers the question asked at step 701 positively. Alternatively, if the poll does not report any changes in the configuration of the input device, the application moves directly to question 607. Thus, after the question of step 701 is answered positively, the corresponding device driver component of the Microsoft Windows NT4 operating system translates the state change of joystick 110 into a string identifying input. Said string is sent to animation instructions 303 at step 702. Animation instructions 303 then translate the input string identifying the actual function triggered on joystick 110 as the appropriate motion clip label and selects the corresponding motion clip within generic motion clips library 304 at step 703.

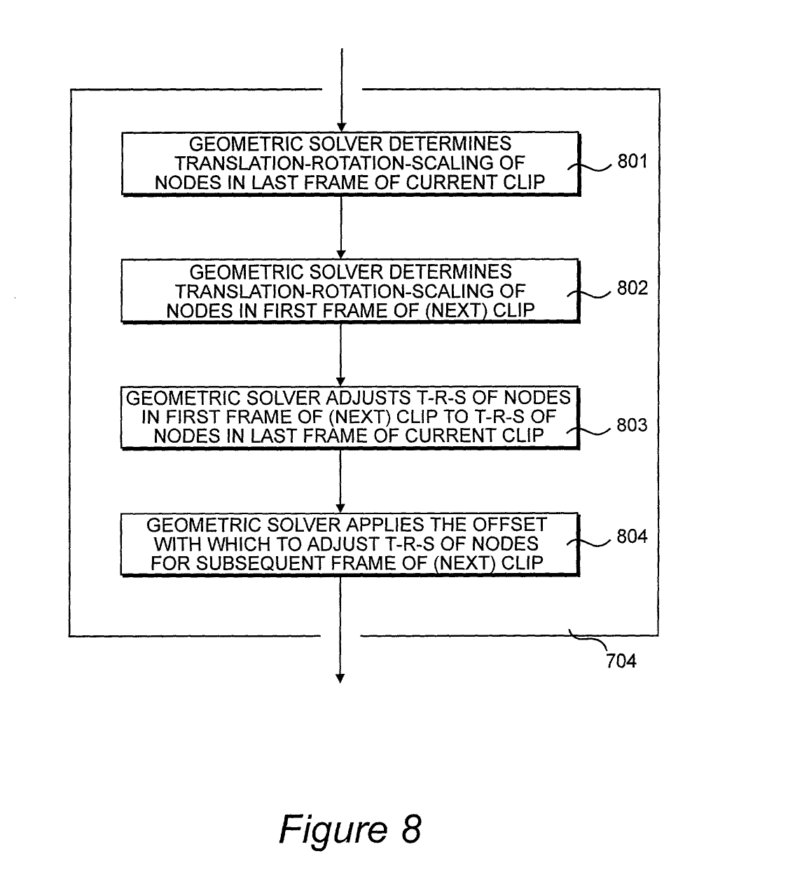

At step 704, the geometric solver of animation instructions 303 adjusts the transform operation between the last frame of the current motion clip and the first frame of the triggered motion clip, the operations of which are summarised in FIG. 8.

At step 801, the geometric solver ascertains the translation, rotation and scaling co-ordinates of each of the nodes within the group of nodes 404 in the last frame of the current motion clip. At step 802, said geometric solver determines the translation, rotation and scaling co-ordinates of each of the nodes within the group of nodes 404 in the first frame of the (next) triggered motion clip. At step 803, said geometric solver determines an offset by adjusting the translation, rotation and scaling co-ordinates of each of the nodes within the group of nodes 404 in the first frame of the (next) triggered motion clip such that said co-ordinates respectively match the translation, rotation and scaling co-ordinates of each of the corresponding nodes within the group of nodes 404 in the last frame of the current motion clip. Finally, at step 804, the geometric solver applies the offset determined at step 803 with which to amend the translation, rotation and scaling co-ordinates of each of the nodes within the group of nodes 404 such that a seamless transform operation is carried out.

Upon completing step 704, animation instructions 303 subsequently add a data set which uniquely defines the nodes' animation and parameters thereof in temporary motion clips list 305 at step 705. Animation instructions 303, possibly but not necessarily in conjunction with the OpenGL portion of utilities 302, subsequently displays the group of nodes 404 animated according to the triggered motion clip as a succession of frames at step 706.

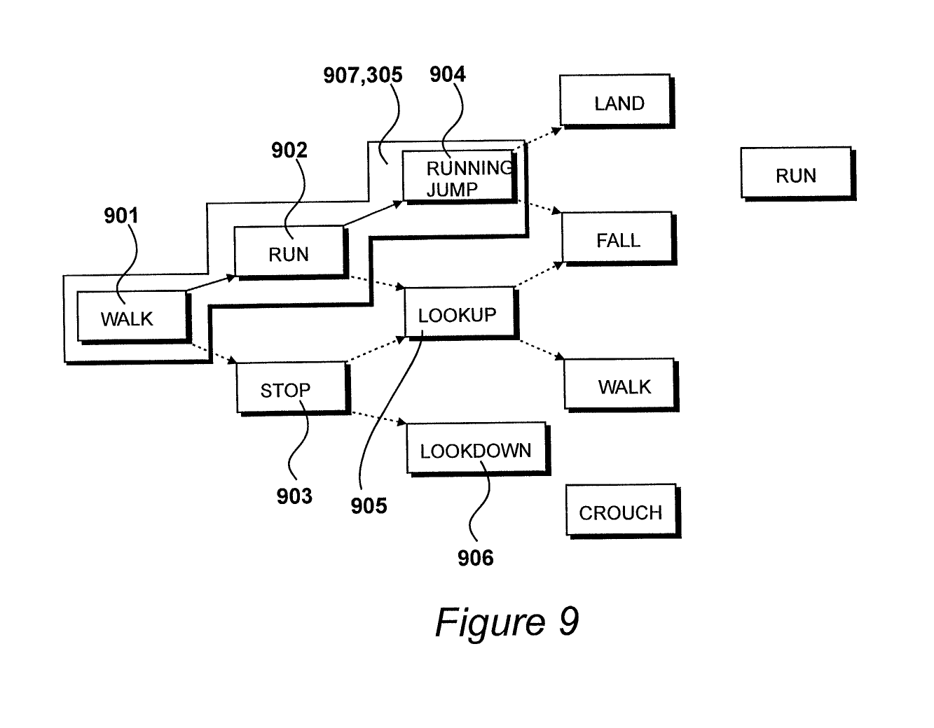

FIG. 9 illustrates the structure of temporary motion clips list 305 which, upon saving the animation sequence generated by the cycle of steps 605 to 607 at step 608, becomes the graphical edit tree of the animation sequence.

Temporary motion clips list 305 is generated within main memory 203 by animation instructions 303 when the first of said added data set which uniquely defines the node' animation and parameters thereof is generated by said animation instructions 303. Each subsequently triggered motion clip generates the addition of one such corresponding data set.

Motion clip triggering can be summarised as the selection and execution of a specific motion clip amidst a plurality of selectable motion clips at a specific time. The real-time activation of a function of joystick 110 triggers its corresponding motion clip as opposed to the motion clip which would be triggered by another of said functions of said joystick 110. Thus the triggering action can be likened to the selection of which path is taken along a pre-set multiple-intersection path as illustrated in FIG. 9.

In the example, it can be observed that the animator has subsequently triggered a walk motion clip 901, a run motion clip 902 and a jump motion clip 904. Had the animator triggered a stop motion clip 903 instead of a run motion clip 902, its next motion clip could have been either a lookup motion clip 905 or a lookdown motion clip 906. Thus, according to the invention, temporary motion clips list 305 includes data sets which uniquely defines the animation 907 of the group of nodes 404 and parameters thereof over a succession of frames spanning a walk motion, a run motion and a jump motion.

The animator may now choose to interrupt the animation sequence at step 607, if his task is to simply animate nodes 404 with a single motion clip. Alternatively, said animator may want to implement further motions within the animation sequence and thus choose not to interrupt the animation sequence.

Thus, with regard to storing the result of the animation sequence of steps 605 and 606, the question is asked at step 607 as to whether an interrupt string is received after said animation sequence is rendered at step 706. If the question asked at step 607 is answered negatively then the process is returned to step 605, wherein an animator may either trigger further motion clips which, as the question at step 701 is answered in the affirmative, are added to the temporary motion list 305 at step 705 or said animator may choose not to provide any further input for a length of time and, as the question of step 701 is answered negatively, let the animation instructions engine loop the animation sequence until such time as a generic motion clip is triggered at step 605 or the animator interrupts the loop at step 607.

Thus, if the animator interrupts the real-time triggering of generic motions with which to animate a specific character at step 607, then at step 608 said animator is given the opportunity to save the animation sequence generated from the cycle of steps 605 to 607.

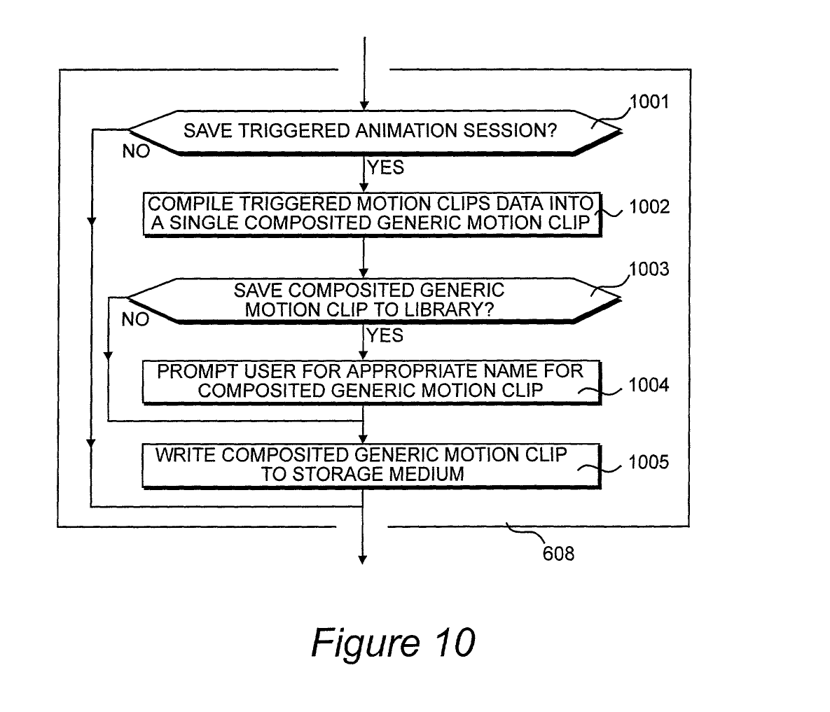

FIG. 10 summarises operations according to the animation instructions 303 in order to save the animation sequence.

At step 1001 a question is asked as to whether the animator wants to save the sequence resulting from performing steps 605 and 606 singularly or repeatedly. If the question of step 1001 is answered negatively then the process is directed directly to step 609 at which point the animation computer system 101 is switched off.

Alternatively, if the animator answers the question of step 1001 in the affirmative, then at step 1002, animation instructions 303 compile the generic motion clips triggered and temporarily stored in temporary motion list 305 into a single generic motion clip. The resulting compiled generic motion clip may now be referred to as a composited generic motion clip comprising one or a plurality of generic motions clips initially stored in generic motion clips library 304.

In the example, an animation sequence comprises a walk followed by a run followed by a jump. Said animation thus consists of triggering three successive motion clips: a ‘walk’ motion clip 401, a ‘run’ motion clip 402 and finally a ‘jump’ motion clip 403. The geometric solver of animation instructions 303 subsequently compiles the translation, rotation and scaling of each of the nodes over the number of frames required to display the entire animation sequence.

Thus, at step 1003, a question is asked as to whether the animator wants to save the composited generic motion clip to the generic motion clips library 304, for instance to animate various specific characters with the same succession of generic motion clips in the future without having to again independently trigger the various generic motion clips which compose said composited generic motion clip. If the question asked at step 1003 is answered negatively then the process is directed to step 1005 whereby the composited motion clip is written onto the storage medium.

Alternatively, if the question asked at step 1003 is answered positively, then animation instructions 303 prompt the animator 113 to designate the composited generic motion clip with an appropriate name at step 1004 so that said composited generic motion clip may be accurately recalled and triggered at a later stage once it has been written onto the medium onto which generic motions library 304 is stored, at step 1005. Said medium is either hard disk drive 204 of animation computer system 101 or CD RAM 104 or Zip disk 106. Upon completing step 608, the animation computer system is eventually switched off at step 609.

The above real-time triggering of motion clips and real-time processing and displaying of nodes defining a generic character animated with said triggered motion clips thus enables an animator to potentially ‘direct’ a character much in the same manner as a film director would direct actors when making a movie, and therefore much creative license is conferred to an animator with regard to how best to animate a character within a specific context. Moreover, as the present invention enables not only the real-time triggering of generic motion clips defining an animation sequence but also the selective archiving of said sequences in storage means, the already-increased reusability of captured performance data is further enhanced by the possibility of creating elaborate generic motion clips composited from other, more basic generic motion clips and confer reusability to said composited generic motion clips, thereby realising substantial economic gains.

What we claim is:

1. An apparatus for generating animation data comprising:
manually controllable input means;
visual display means;
processing means;
memory means; and
storage means for storing input animation sequences and output animation sequences, wherein said memory means includes
instructions to configure said processing means to display a character that can be animated;
instructions to trigger the reading of said input animation sequences in response to manual operation of said manually controllable input means;
instructions to animate said character in response to said input animation sequences; and
instructions to store said triggered animation sequence in said storage means as an output animation sequence.

2. An apparatus according to claim 1, wherein said input animation sequences are motion clips either captured from performance data or keyframes.

3. An apparatus according to claim 2, wherein said motion clips are a sequence of translation, rotation and scaling of a set of nodes over time.

4. An apparatus according to claim 3, wherein said nodes define a character topology comprising body parts sensibly similar to body parts, the motion of which is captured from performance data.

5. An apparatus according to claims 1 to 4, wherein said animation of said set of nodes includes a transform operation carried out by a geometric solver on the last and the first frame of a first and a second triggered motion clip respectively.

6. An apparatus according to claim 1, wherein said manual operation of said manually controllable input means is configurable by means of said instructions.

7. A method of generating animation data, comprising the steps of:
displaying a character that can be animated;
triggering the reading of input animation sequences in response to manual operation of manually controllable input means;
animating said character in response to said input animation sequences; and
storing said triggered animation sequence in storage means as an output animation sequence.

8. An apparatus according to claim 1, wherein said input animation sequences are motion clips either captured from performance data or keyframes.

9. An apparatus according to claim 8, wherein said motion clips are a sequence of translation, rotation and scaling of a set of nodes over time.

10. A method according to claim 8, wherein said motion clips are stored in a library or database.

11. An apparatus according to claim 10, wherein said nodes define a character topology comprising body parts sensibly similar to body parts, the motion of which is captured from performance data.

12. A method according to claim 7, wherein said manual operation of said manually controllable input means is configurable by means of said instructions.

13. A method according to claim 7, wherein said manual operation of said manually controllable input means is accomplished in real-time.

14. A method according to claim 7, wherein said triggering of the reading of said input animation sequences is accomplished in real-time.

15. A method according to claim 7, wherein said animation of said character comprises generic body part motions captured from performance data applied to said sensibly similar body parts of said character.

15. A method according to claim 7, wherein said animation of said character is accomplished in real-time.

16. A method according to claim 7, wherein said output animation sequence is stored as an input animation sequence for reading when subsequently triggered and animating a plurality of characters.

17. A computer-readable medium having computer readable instructions executable by a computer such that, when executing said instructions, a computer will perform the steps of:
displaying a character that can be animated;
triggering the reading of input animation sequences in response to manual operation of manually controllable input means;
animating said character in response to said input animation sequences; and
storing said triggered animation sequence in said storage means as an output animation sequence.
